(19) United States
(12) Patent Application Publication
(10) Pub. No.: US 2019/0322229 A1
(43) Pub. Date: Oct. 24, 2019

(54) Intelligent Vehicle Registration Plate

(71) Applicant: Maher Ibrahim Al Abed, Abu Dhabi (AE)

(72) Inventor: Maher Ibrahim Al Abed, Abu Dhabi (AE)

(21) Appl. No.: 15/959,309

(22) Filed: Apr. 23, 2018

(51) Int. Cl. B60R 13/10

(52) U.S. Cl. CPC B60R 13/10; B60R 25/102

(57) ABSTRACT

An intelligent vehicle registration plate mounted on a first vehicle comprises sensors, a non-transitory computer readable storage medium (NCRSM), and a processor. The sensors generate and transmit sensor data variables (SDV) based on detected parameters of a first vehicle. The data communications module (DCM) receives a request to locate a vehicle of interest. The analyzing module dynamically analyzes the SDV to identify a match between the first vehicle and the vehicle of interest and notifies the server based on the SDV exceeding a threshold. The DCM notifies the server of the location of the vehicle of interest. The system adds smart and secure functions for identification of registered vehicles, for example, early detection of severe accidents, detecting dangerous drifting on the streets, call and track feature, securing plate numbers from dismantling, applying basic analytics like number, type, and location of incidents within a certain period, etc.

### TECHNICAL FIELD OF THE INVENTION

The invention disclosed herein generally relates to vehicle safety systems. More particularly, the invention disclosed herein relates to an intelligent vehicle registration plate for providing a traceable and encrypted vehicle registration plate. Further, the intelligent vehicle registration plate allows a registration authority to determine reckless drivers, location of accidents, formulate quicker incident responses, track vehicles during emergencies, etc. The invention is based on retrofitting the traditional rare vehicle registration plate of the vehicles with an electronic device to assure turning the existing vehicle registration plate into a smart one with security and safety features. Utilizing the existing metallic vehicle registration plate has multiple reasons here and allowing all other traditional solutions for traffic management based on detecting or reading the metallic vehicle registration plate to function as is without disturbing its functionality is one of those reasons.

### BACKGROUND

Existing conventional vehicle registration plate are usually metallic plates attached to vehicles to visually identify vehicles and consequently determine the details of the owners. Unfortunately, such vehicle registration plates are usually not secure as they can be swapped/changed/stolen easily and pose a high security risk for vehicle owners. Although, there are several anti-theft security alarms available in the market, such alarms can be effectively bypassed by a skilled individual. Moreover, there is no direct mechanism installed in current vehicles that enable authorities to detect major incidents and report it to registration entities in case of specific problems or accidents that could happen like severe accidents, for example, vehicle turn over, highway crashes, reckless driving, dangerous drifting on public streets, stolen vehicles having a dismantled registration plate, etc.

Even harmless events such as a worried parent who is not able to reach his/her child could be solved using an intelligent vehicle registration plate communicating with a central server or authority. A smart system, which allows a concerned authority to receive improved information about a vehicle or an emergency at a particular location thereby improving incident response, is therefore required. Moreover, existing digital vehicle registration plate require long wiring to reach the power source of the vehicle to operate. These devices raise an extra load on the power source of the vehicle and requires complex wiring from the registration plate to the power source of the vehicle. As such, existing devices fully depend on the power of the vehicle to run failing which the device completely shuts down. Further, existing devices using their own source of battery serve different purposes like presenting ads on a digital screen plate, or they show the current registration status whether it is expired or not and those serve a different purpose and implies a complete change of the current metallic plate number. Alternately, other systems require independent infrastructure related to network of communications, so each one serves a different and non-related purpose to what is presented by this invention. A smart system, which uses an independent source of power to operate, is required. Furthermore, a system, which requires no wiring and is installed as an enclosure that includes all required devices behind the rare metallic number to reduce complexity of installation, is required.

Hence, there is a long felt but unresolved need for a system, which allows a concerned authority to receive improved information about a vehicle or an emergency at a particular location thereby improving incident response. Additionally, there is a need for a system, which uses an independent source of power to operate. Furthermore, there is a need for a system, which requires no wiring and is installed as an enclosure that includes all required devices behind the rare metallic number to reduce complexity of installation. Additionally, it does not affect the running operation of other traditional systems that are based on current metallic plates like radar systems, red signal crossing cameras, visual identifications, etc.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The intelligent vehicle registration plate disclosed herein addresses the above-mentioned need for a system, which allows a concerned authority to receive improved information about a vehicle or an emergency at a particular location thereby improving incident response. Additionally, the invention addresses the need for a system, which uses an independent source of power to operate. Furthermore, the intelligent vehicle registration plate addresses the need for a system, which requires no wiring and is installed as an enclosure that includes all required devices behind the rare metallic number to reduce complexity of installation and to transform the current traditional metallic vehicle registration plate to an intelligent registration plate.

It is an object of the present invention to provide a solution that comprising a hardware in combination with firmware that will ensure smart and secure vehicle registration plate. Existing registration plates are usually metallic plates attached to vehicles to visually identify the vehicles and the details of the owners. Unfortunately, those plate numbers are usually not secure and can be swapped/changed/stolen for any security breach purpose. The main objective of intelligent vehicle registration plate is to detect issues and to have a fast incident response in addition to adding more intelligent, smart, and secure functions for identification of registered vehicle, for example, early detection of severe accidents “like the Turnover”, detecting inappropriate way of driving “dangerous drifting on the streets”, “call and track” feature involving calling a specific vehicle registration plate and tracking the related vehicle if required, securing vehicle registration plate from dismantling, applying basic analytics like number of incidents, type of incidents, and location of incidents within a certain period, etc.

The intelligent vehicle registration plate mounted on a first vehicle comprises a plurality of sensors, a non-transitory computer readable storage medium, and at least one processor. The sensors are configured to detect one or more parameters of the first vehicle. Further, the sensors are configured to generate and transmit sensor data variables based on the detected one or more parameters of the first vehicle. The non-transitory computer readable storage medium is configured to store a first data set comprising a unique identifier database verified by a server and a set of threshold sensor data variables associated with the first vehicle. The processor is communicatively coupled to the non-transitory computer readable storage medium and configured to execute a set of computer program instructions defined by modules of the intelligent vehicle registration plate. The modules of the intelligent vehicle registration plate comprise a data communications module and an analyzing module.

The data communications module is configured to receive a request to locate a vehicle of interest from the server and the transmitted sensor data variables from the sensors. The analyzing module is configured to dynamically analyze the received sensor data variables to identify a match between the first vehicle and the vehicle of interest. The analyzing module is further configured to notify the server based on the sensor data variables associated with the first vehicle exceeding the set of threshold sensor data variables. The data communications module is further configured to notify the server of the location of the vehicle of interest. Further, the server is configured to receive the sensor data variables exceeding the set of threshold sensor data variables and analyze the sensor data variables to determine a course of action.

The intelligent vehicle registration plate further comprises an independent power source for supplying power to the intelligent vehicle registration plate. Additionally, it contains a power management module for optimizing power supply to the intelligent vehicle registration plate to ensure longer battery life and reduction in wastage of power. The intelligent vehicle registration plate draws power from the independent power source using a special matrix for power consumption which defines mode and contains pre-defined active time of operation of such modes like standby mode, normal mode, tracking mode or secure tracking mode of the system depending on the algorithm and analyzed sensory data.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a schematic diagram of the intelligent vehicle registration plate.

FIG. 2 exemplarily illustrates a flowchart showing different modes of operation of the intelligent vehicle registration plate.

FIG. 3 shows an exploded view of one exemplary embodiment of the intelligent vehicle registration plate with overall components with their placement.

### DETAILED DESCRIPTION OF THE INVENTION

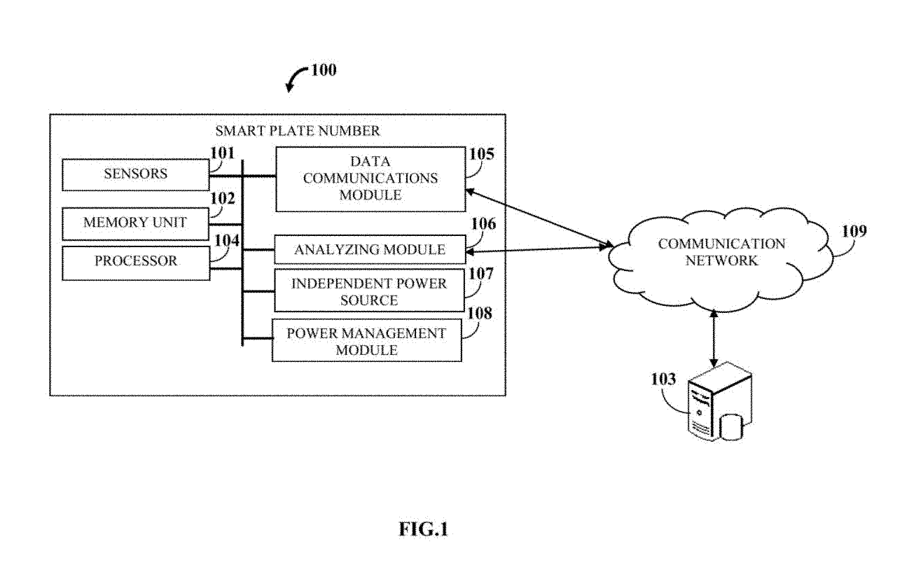

FIG. 1 exemplarily illustrates a schematic diagram of an intelligent vehicle registration plate 100. The intelligent vehicle registration plate 100 comprises of an existing metallic vehicle registration plate fitted with a smart device having its own power source. Essentially, the invention is based of retrofitting an existing metallic vehicle registration plate with the smart device comprising processors and sensors to assure turning the existing vehicle registration plate into an intelligent one with security and safety features. Utilizing the existing metallic vehicle registration plate has a major reason here, which is allowing all other traditional solutions for traffic management based on detecting or reading the metallic registration plate to function as is without disturbing its functionality. A comprehensive electronic system is positioned inside an enclosure that has the exact dimensions of the current rare metallic registration plate, where the rare metallic plate number will be fitted on top of it to form the intelligent vehicle registration plate 100. In an embodiment, the enclosure size and fitting are customized based on the size of the rare metallic vehicle registration plate based on the country of origin. The intelligent vehicle registration plate 100 is mounted on a first vehicle and comprises a plurality of sensors 101, a non-transitory computer readable storage medium (NCRSM) 102, and at least one processor 104. As used herein, the “non-transitory computer readable storage medium” refers to a memory unit 102 as exemplarily illustrated in FIG. 1.

The sensors 101 are configured to detect one or more parameters of the first vehicle. Further, the sensors 101 are configured to generate and transmit sensor data variables (SDV) based on the detected one or more parameters of the first vehicle. In an embodiment, the sensors 101 used are a combination of angular velocity sensors, motion sensors, accelerometers, gyrometers, etc. The sensors 101 detect one or more parameters, for example, motion, and an angular velocity of the first vehicle. In an embodiment, the memory unit 102 stores a first data set comprising a unique identifier database verified by a server 103 and a set of threshold sensor data variables associated with the first vehicle. The server 103 may be a central vehicle registration server 103 or merely an electronic device, such as a mobile device, a laptop, a personal computer, a tablet, etc. As used herein, “threshold sensor data variables” refer to predefined limits of sensor values that are set in the firmware to be within acceptable levels. Any sensor value exceeding the preset level is categorized as an event and triggers a notification at the server 103 or a designated electronic device. For instance, if a vehicle is stolen and the metallic vehicle registration plate has been dismantled, a notification is sent to the server 103.

The processor 104 is communicatively coupled to the memory unit 102 and configured to execute a set of computer program instructions defined by modules of the intelligent vehicle registration plate 100. The processor 104 refers to any one or more microprocessors, central processor (CPU) devices, finite state machines, computers, microcontrollers, digital signal processors, logic, a logic device, a user circuit, an application specific integrated circuit (ASIC), a field-programmable gate array (FPGA), a chip, etc., or any combination thereof, capable of executing computer programs or a series of commands, instructions, or state transitions. In an embodiment, the processor 104 is implemented as a processor set comprising, for example, a programmed microprocessor and a math or graphics co-processor. The processor 104 is selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines (IBM®)processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc.

The modules comprise a data communications module (DCM) 105 and an analyzing module 106. The data communications module (DCM) 105 is configured to receive a request to locate a vehicle of interest and receives the transmitted sensor data variables from the sensors 101. As used herein, a “vehicle of interest” may be a lost vehicle, a stolen vehicle, a vehicle driven by a reckless driver, a vehicle committing a traffic violation, etc. The vehicle of interest may also be a vehicle whose location must be traced in the case of an emergency. The communication module is selected, for example, from Simcom®, Huawei®, Sagemcom , Telit®, Siemens®, Quectel®, etc.

The especially programmed analyzing set of instructions or firmware hereinafter referred as an analyzing module 106 is configured or stored into the memory unit 102 communicatively coupled to the processor 104 to dynamically analyze the received sensor data variables to identify a match between the first vehicle and the vehicle of interest. The analyzing module 106 is further configured to notify the server 103 based on the sensor data variables associated with the first vehicle exceeding the set of threshold sensor data variables. The data communications module (DCM) 105 further configured to notify the server 103 of the location of the vehicle of interest. The server 103 is configured to receive the sensor data variables exceeding the set of threshold sensor data variables and analyze the sensor data variables to determine a course of action. The course of action may include alerting rescue personnel in the event of accidents, etc. Further, the intelligent vehicle registration plate 100 comprises an independent power source 107 for supplying power to the intelligent vehicle registration plate 100. In an embodiment, a power management module 108 is utilized for optimizing power supply to the intelligent vehicle registration plate 100 to ensure longer battery life and reduction in wastage of power. The intelligent vehicle registration plate 100 may have additional power saving mode wherein the intelligent vehicle registration plate 100 draws power from the independent power source 107 using special matrix for power consumption based on operating modes such as the standby, the active, the tracking and the high secure tracking mode. Each such mode has predefined specific active time in matrix thus based on this matrix the system reduces power consumption and optimize the power for a long span.

The intelligent vehicle registration plate 100 can be programmed to initiate automatically only after a motion sensor 101 detects movement of the first vehicle. Moreover, the intelligent vehicle registration plate 100 can be programmed to shut down automatically or enter standby mode when the first vehicle is powered off for a preset time, for example, sixty seconds. This feature of the intelligent vehicle registration plate 100 allows power saving and reduces wastage of energy. In an embodiment, the intelligent vehicle registration plate 100 is powered by an independent power source 107. Thus, the intelligent vehicle registration plate 100 does not require complex and long wiring circuits for installation. This increases usability from the point of view of an unskilled individual. Furthermore, installation time and complexity are drastically reduced.

The data communications module (DCM) 105 receives a request to locate a vehicle of interest from either a central vehicle registration server 103, for example, a computer, a laptop, a mobile phone, etc. As used herein, the “server” is an electronic device, for example, a personal computer, a tablet computing device, a mobile computer, a mobile phone, a smartphone, a portable computing device, a laptop, a personal digital assistant, a wearable device such as a touch centric device, a workstation, a server, a client device, a portable electronic device, a network enabled computing device, an interactive network enabled communication device, etc. In an embodiment, the electronic device is a hybrid device that combines the functionality of multiple devices. In another embodiment, computing equipment, for example, one or more servers are associated with one or more online services. The vehicle to server to vehicle communication is typically achieved over a communications network 109.

The communication network 109 is a network, for example, a long-term evolution (LTE) mobile communication network, etc. Moreover, the existing metallic vehicle registration plate is retrofitted with hardware including an electronic circuit with low power and compact microcontrollers, accurate sensors 101 to detect location, movements, angular velocity etc., via LTE connection for fast & precise communication to transfer all the acquired data from sensors 101 to a designated control room. Furthermore, the intelligent vehicle registration plate 100 has several smart operating modes such as standby, active/normal, tracking and the high secure tracking mode which are configured in the firmware to optimize power consumption by its independent power source 107 that feeds the vehicle registration plate with power for around 3 years without charging. The enclosure of the intelligent vehicle registration plate 100 is all weather proof to protect all components within the intelligent vehicle registration plate from the harsh environmental conditions. Retrofitting current available vehicle registration plate with the intelligent vehicle registration plate 100 ensures a smart, secure, and intelligent vehicle registration plate that can identify breaches and early detection of severe accidents like “the turnover”, detecting reckless drivers, for example, dangerous drifting on the streets, or any such incidents, along with the functionality and advantages of the traditional systems based on metal vehicle registration plate as optical character recognition or automatic number plate recognition, traffic management and control, etc. Further, the main system in the control room, for example, the server 103 calls a specific vehicle registration plate to track that specific vehicle in case of incident such as pursuing a vehicle in addition to the cases of other incidents such as turnover or plate dismantling where the intelligent registration plate itself communicates to the server and inform such incidents along with its current location. Moreover, the intelligent vehicle registration plate 100 has its own battery source which can feed the vehicle registration plate with power for around 3 years without charging. Additionally, the enclosure of the intelligent vehicle registration plate 100 is all weather proof to protect all components within the vehicle registration plate from harsh environmental conditions.

In an embodiment of the present invention, the processor 104 collects all the generated data from sensors 101 based on pre-configured modes of operation in the embedded firmware and sends it to the software of the control room through the communication module (105) and a communication network (109) which is more preferably, but not limited to, a GSM/LTE, firmware will have multiple operation modes such as standby mode, normal mode, and secure tracking mode where each mode is configured to perform a certain task of collecting the incidents at specific periods and configured to optimize the power consumption of the installed battery within the Secure and intelligent vehicle registration plate 100. Finally, all the collected data is sent through LTE to the control room software and used to show alerts or notifications received from the hardware and will be used for improved incident response. In another embodiment, the present invention might have extra operation modes like tracking mode, which could help in building some statistics and analysis for some other features like the road congestions at a certain time and location, and the software can be equipped with analytics module to perform advanced analytics on the data collected from the hardware. The intelligent vehicle registration plate 100 can work completely in autonomous fashion, where there is no need for any wired connection with the vehicles' computers or power or internal systems. Another advantage of the present invention is that it can be turned in to a commercial solution and offered as an enterprise solution to all vehicle registration authorities across the world. Further, turning the traditional vehicle's registration plate into an intelligent, smart and secure vehicle registration plate implies working in a very small area at the back side of the registration plate number which adds another unique proposition and the overall solution can be considered as a unique idea in the world of interne-of-things (IoT) and digital transformation.

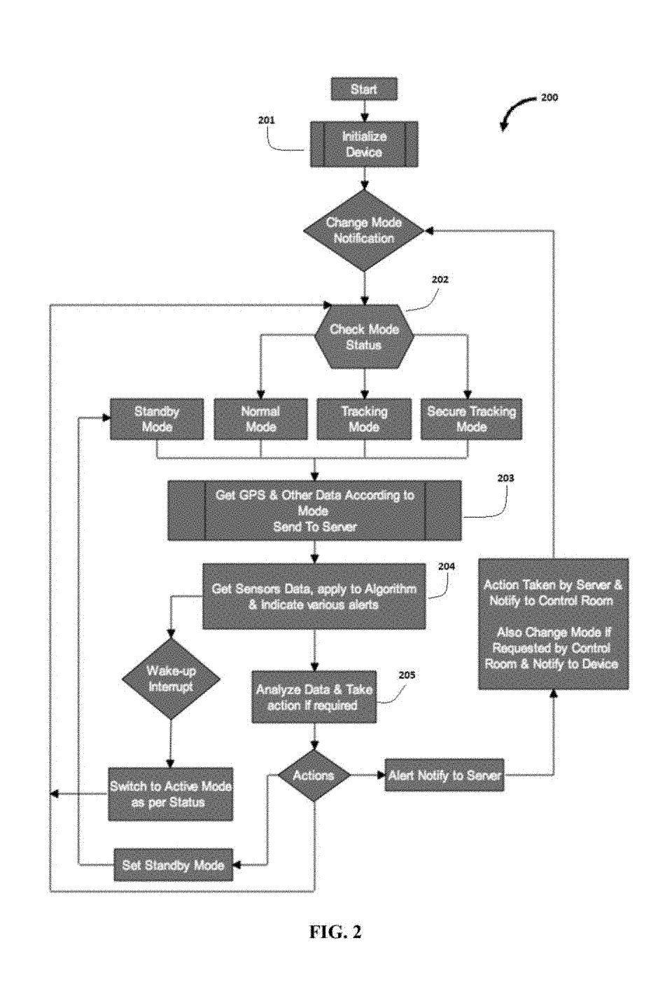

FIG. 2 exemplarily illustrates a flowchart 200 showing different modes of operation of an intelligent vehicle registration plate 100. At step 201, the component of the intelligent vehicle registration plate 100 installed on the vehicle is initialized. During initialization, the GPIO (General Purpose Input Output) Pin, Clock and Timer, I2C peripherals, and the universal asynchronous receiver transmitter (UART), SPI, etc., are initialized. The device is configured with a unique ID. Further, all sensors, GSM, and GPS components are checked by taking dummy output. At step 202, the intelligent vehicle registration plate 100 checks the mode currently being operated. The mode change status byte is checked at step 202. As used herein, a “status byte” is a variable. Depending on these variable values we define any of the different modes (Standby/Normal/Tracking/Secure Tracking) as per current scenario. By default, the device works in the normal mode.

At step 203, the intelligent vehicle registration plate 100 gets GPS data and other data, for example, data frame, data from sensors, etc., and sends them to the remote server depending on mode of operation selected. At step 204, the intelligent vehicle registration plate 100 gets sensor data variables from the sensors and applies algorithms to determine if the variables are within preset threshold values. If the sensor data variables are above acceptable limits, the intelligent vehicle registration plate 100 determines the relevant action to be taken or notifications to be sent to the server in step 205. At step 205, the data from sensors is analyzed and processed by applying algorithms on them by the server to determine a course of action. Depending on the algorithm, the device will decide whether to go in standby mode or continue in a current mode. Depending on the analyzed data, the intelligent vehicle registration plate 100 sends a vehicle registration plate removal notification, a drifting notification, an accident notification, etc., to the server. The standby mode is activated, when the sensor detects the vehicle is at a fixed location for some time.

The normal mode is activated when the sensor generates a wake-up signal device or when the server sends a notification. When an event such as an accident, reckless driving, of the first vehicles, etc., is detected or a request is received from the server, the tracking mode is activated. When the server sends notification, the device goes into secure tracking mode.

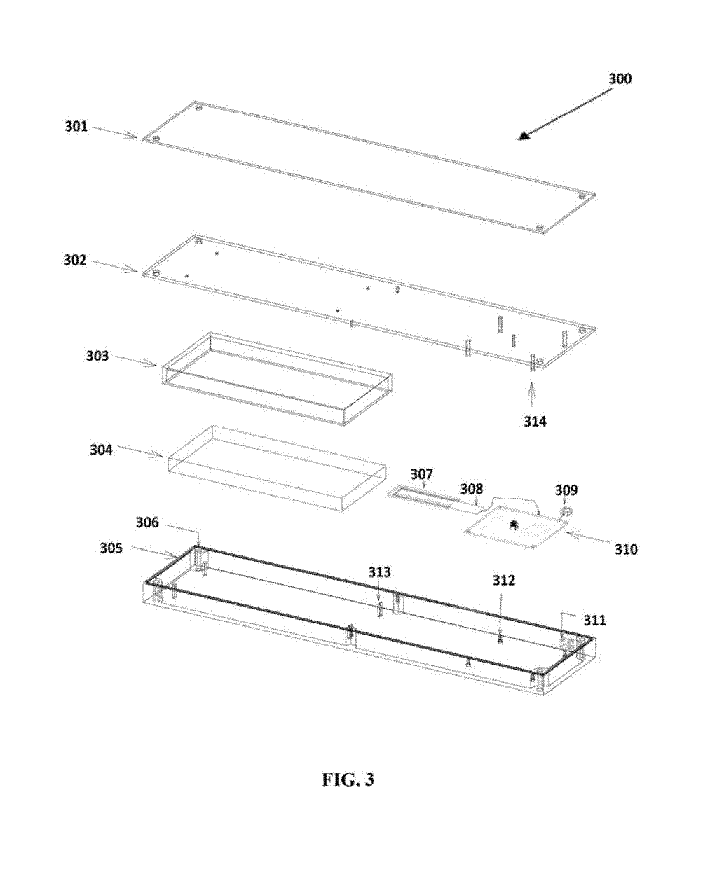

FIG. 3 shows an exploded view of one exemplary embodiment of the intelligent vehicle registration plate with overall components and their placement. It shows a traditional rare metal vehicle registration plate 301, a top cover 302 that connects enclosure to the metallic vehicle registration plate 301, a battery cover 303 to enclose and protect battery/independent power source 304 from harsh conditions addition to the other electrical components from being affected in case of leakage in battery/independent power source 304, a base plate 305 with rubber gasket to enclose all the components at its inside portion, screw holes 306 is provided to screw and hold rare metallic vehicle registration plate 301 with top cover 302 and base plate 305 forming whole enclosure of the intelligent vehicle registration plate to enclose all the components except metallic vehicle registration plate 301 that is placed on the top of the enclosure, a fixture 307 for the antenna 308 of communication module 105, GPS antenna 309 with housing 311 to provide location of the said intelligent vehicle registration plate, a circuit board 310 which holds and connects together Processor, memory unit, communication module, analyzing module, sensors etc., a bottom fitting stud 312 and a top fitting stud 314 for circuit board and a holding stud for battery and its cover 313. This is just one exemplary embodiment out of many possible combination of laying out different units and system in accordance with one or more embodiments of the present invention.

The foregoing examples have been provided merely for the purpose of explanation and are in no way to be construed as limiting of the intelligent vehicle registration plate 100, disclosed herein. While the intelligent vehicle registration plate 100 has been described with reference to various embodiments, it is understood that the words, which have been used herein, are words of description and illustration, rather than words of limitation. Further, although the intelligent vehicle registration plate 100 has been described herein with reference to particular means, materials, and embodiments, the intelligent vehicle registration plate 100 is not intended to be limited to the particulars disclosed herein; rather, the intelligent vehicle registration plate 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the intelligent vehicle registration plate 100 disclosed herein in their aspects.

1. An intelligent vehicle registration plate mounted on a first vehicle, the intelligent vehicle registration plate comprising:
a metallic plate number retrofitted with a smart device, the smart device comprising:
a plurality of sensors configured to detect one or more parameters of the first vehicle, the sensors configured to generate and transmit sensor data variables based on the detected one or more parameters of the first vehicle;
a non-transitory computer readable storage medium configured to store a set of threshold sensor data variables associated with the first vehicle;
at least one processor communicatively coupled to the non-transitory computer readable storage medium, the at least one processor configured to collect the sensor data variables and to select the mode of operation according to the firmware instructions; and
the server configured to receive the sensor data variables exceeding the set of threshold sensor data variables and analyzes the sensor data variables to determine the cause of action.

2. The intelligent vehicle registration plate of claim 1, wherein the sensors are one of an angular velocity sensor and a motion sensor.

3. The intelligent vehicle registration plate of claim 1, wherein the one or more parameters comprise motion and an angular velocity of the first vehicle.

4. The intelligent vehicle registration plate of claim 1, wherein the processor is one of the microprocessors, CPU devices, finite state machines, microcontrollers, digital signal processors, logic devices, a user circuits, an application specific integrated circuits (ASIC), a field-programmable gate arrays (FPGA) or any combination thereof.

5. The intelligent vehicle registration plate of claim 1, wherein the first vehicle, the first vehicle, and the vehicle of interest are selected from the group consisting of a motorbike, a car, a jeep, a trailer, a bus, and a pickup truck.

6. The intelligent vehicle registration plate of claim 1, further comprising a communication module configured to receive a request to locate the first vehicle from central server system and to transmit the sensor data variables to the server.

7. The intelligent vehicle registration plate of claim 1, further comprising an analyzing module to dynamically analyze the received sensor data variables to identify a match between a first vehicle and a vehicle of interest. Additionally, to notify the server for exceeding of sensor data variables from the set of threshold sensor data variables.

8. The intelligent vehicle registration plate of claim 1, further comprising an independent power source for supplying power to the intelligent vehicle registration plate.

9. The intelligent vehicle registration plate of claim 1, further comprising a power management module for optimizing power supply to the intelligent vehicle registration plate.

10. The intelligent vehicle registration plate of claim 8, wherein the power management module draws power from the independent power source using special matrix for power consumption according to the mode of operation hence decreases power consumption and optimizes power.

11. The intelligent vehicle registration plate of claim 1, wherein the intelligent vehicle registration plate is enclosed in an enclosure to save all components from harsh weather conditions.

12. The intelligent vehicle registration plate of claim 11, wherein the size of the enclosure is customizable based on the size of the metallic plate number.

13. The intelligent vehicle registration plate of claim 11, wherein the material of the enclosure is chosen from, but not limited to, the group consisting of plastic, fiber-glass, wood, metals such as Stainless steel, Aluminum or a combination thereof.
